(19) United States
(12) Patent Application Publication
(10) Pub. No.: US 2017/0046096 A1
(43) Pub. Date: Feb. 16, 2017

(54) STRUCTURING PAGE IMAGES IN A MEMORY

(71) Applicant: HEWLETT PACKARD ENTERPRISE DEVELOPMENT LP, Houston, TX (US)

(72) Inventors: Goetz Graefe, Madison, WI (US); Haris Volos, Palo Alto, CA (US); Hideaki Kimura, Palo Alto, CA (US); Harumi Kuno, Cupertino, CA (US); Alistair Veitch, Mountain View, CA (US); Joseph Tucek, Palo Alto, CA (US); Alvin AuYoung, San Jose, CA (US)

(21) Appl. No.: 15/305,389

(22) PCT Filed: Apr. 24, 2014
(86) PCT No.: PCT/US2014/035364

§ 371 Date: Oct. 20, 2016

(51) Int. Cl. G06F 3/06

(52) U.S. Cl. CPC G06F 3/0644; G06F 3/0604; G06F 3/064; G06F 3/0652; G06F 3/0673

(57) ABSTRACT

Approaches for structuring a plurality of page images in-memory are described in various examples of the present disclosure. In one example, a unique page identifier provided within a reference page image is identified. The unique page identifier is associated with a target page image stored in-memory. Once identified, the page identifier associated with the target page image is replaced with a location specific identifier of the target page image, wherein the location specific identifier is based on an in-memory location of the target page image.

### BACKGROUND

Traditional databases, as opposed to in-memory databases, use a transient memory for processing in-memory copies of data obtained from disk storage or any other persistent storage medium. The data to be processed (i.e., read and written) is first copied from the disk storage, and brought into the transient memory for processing. The transient memory, such as a buffer pool holds one or more database pages for reading and modifying data. The data access times for the transient memory, such as the buffer pool, are less when compared with disk storage. Consequently, buffer pools allow quicker processing of data as the data can be processed directly from the transient memory, and not from the disk storage.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components:

FIG. 1a illustrates a system environment for structuring data pages within a buffer pool, according to an example of the present disclosure.

FIG. 1b illustrates a system for structuring data pages within a buffer pool, according to an example of the present disclosure.

FIG. 2 illustrates a system for structuring data pages within a buffer pool, according to another example of the present disclosure.

FIG. 3a illustrates a hierarchical representation of stored page images, according to an example of the present disclosure.

FIG. 3b illustrates representations of buffer pool without, and with structuring of data pages, according to an example of the present disclosure.

FIG. 4 illustrates a method of structuring data pages within a buffer pool, according to an example of the present disclosure.

FIG. 5 illustrates a method of structuring data pages within a buffer pool, according to another example of the present disclosure.

FIG. 6 illustrates a method of structuring data pages within a buffer pool, according to yet another example of the present disclosure.

FIG. 7 illustrates an example network environment, implementing a non-transitory computer-readable medium for structuring data pages.

### DETAILED DESCRIPTION

Approaches for structuring data pages stored in-memory are described in various examples of the present disclosure. Generally, traditional database systems use a transient memory, such as a buffer pool, to store in-memory copies or images of working data. The data access times for the transient memory are less, when compared with the data access times for mass storage devices.

The working data should be understood as the data which is processed by the database systems. The working data associated with the database may include data fetched from the database's persistent storage medium, or may also include data which is produced as a result of processing other data. The working data is typically fetched from a slower memory, such as a disk, where such data is maintained in a persisted storage. Once the data is fetched, it is placed in the faster transient memory. Examples of such faster memories include volatile DRAM. Examples of memories which store data in a persistent state include magnetic (spinning) disk, solid state (flash) drives (SSD), phase change memories, and memristors. For such persistent storage mediums, the access times are generally larger when considered with respect to transient memories. Within the buffer pool, the data is further processed depending on one or more search request or processing requests. The buffer pool in turn is logically composed of an array of frames. Any frame may store an in-memory image of a page. Each page therefore may be considered to store portions of data which are to be processed. It is in such frames that the buffer pools stores data in-memory, as page images. The buffer pool can be used to enable fast in-memory processing of any data, including data stored on any volatile or non-volatile memory. For example, the buffer pool may enable fast local in-memory processing of data stored on a remote memory. In this manner, buffer pool offers a storage medium that is faster and easier to access.

The amount of memory available as part of the buffer pool is however limited. During the course of operation, the amount of available memory within the buffer pool may not be sufficient for processing further requests. For example, it may happen that a large proportion of frames within the buffer pool already hold an in-memory page image. In such a case, adequate space for new page images may not be available. For efficient operation, in-memory page images may be continuously moved in and out of the frames within the buffer pool. As a result, pages corresponding to the data which may be most likely used may be determined and stored in the frames within the buffer pool.

Each of the frames within the buffer pool stores a unit of data. For example, a traditional database system might logically manage its data in the form of pages. Generally, a page within a memory may be considered as a unit of data. Considering the entire buffer pool, multiple pages may be logically linked so as to form the entire data that is processed. It should be understood that the data as such is not transferred to the buffer pool. The page includes an image of the data used for processing. As a result, the page may also be referred to as an in-memory page image, or interchangeably, as a page image. For example, within a database, a record of a table represented by a row of data, may be accessed for further processing. When accessed, a page image including an image of the record being accessed is placed in the buffer pool. In case, prospectively, if the record is to be accessed, the same is accessed within the buffer pool and not retrieved from the slower persistent storage medium, such as disk storage.

Each of the page images may be further associated with each other and may be arranged in a hierarchical manner. When arranged, each of the page images should be understood as a node within the hierarchical structure. The nodes may be a child node or a parent node. Each child node is referenced by way of unique page identifiers included within its parent node. For example, the page images may be arranged in the form of a B-tree index. For a B-tree index, more than two children nodes may be referenced from a parent node.

Each of the nodes, i.e., a page image, is associated with a unique page identifier when stored within the persistent storage medium. An example of such a unique page identifier includes a page ID. As mentioned previously, each parent node may include one or more unique page identifiers associated with the child node. The unique page identifier specified within the parent node may therefore be considered to reference an intended child node. Continuing with the present example, the page ID serves as the basis for identifying any one or more of the pages which is to be accessed. Generally, association between the parent and their corresponding children nodes may be implemented using pointers. For example, the parent node may include a pointer referencing the unique page identifier of a child node.

For efficient processing, pages storing data which would be most often used for processing data, are obtained and stored into the buffer pool. When the page is obtained from the disk storage and store into the buffer pool, its unique page identifier may be retained. For example, when a page fetched from a mass storage is obtained, the corresponding page image may be stored within a frame. Within the frame, the page image is associated with the unique page identifier, such as a page ID.

Within the buffer pool, a mapping is maintained which maps the unique page identifier, such as the page ID, to an in-memory location of the page image to be accessed. If the buffer pool is organized as a set of frames, where each frame holds an in-memory working copy of a page, the in-memory location may be identifiable through its frame identifier (frame ID). The mapping of the unique page identifier, such as the page ID, with the exact in-memory location where the page is stored forms the basis of performing operation for such databases. The mapping may be implemented as a data structure. However, during processing the data structure holding the mapping may be latched, i.e., any changes to the contents of the data structure while it is being searched or accessed are not allowed. Therefore, for multiple requests, the mapping has to be latched continuously. It should be understood that each time the mapping is latched, all requests to modify the contents of the data structure may have to wait for the latch to be released, even though other requests to read the contents of the data structure may still be processed. In such cases, other requests for modifying the contents of the data structure will have to wait till the latch is released, before the mapping made accessible again. In cases where the number of requests are large, the mapping would be read-latched, i.e., is rendered inaccessible for update requests for longer contiguous durations. Furthermore, it should be understood that even in the absence of contention of the mapping, acquiring a latch may impose a significant computational cost.

In such cases, maintaining and using mapping data structures to navigate between the unique page identifier associated with the physical in-memory image of a page causes overheads which are computationally expensive and adversely affect the read-write times. Examples of such mapping data structures include a hash table mapping within the buffer pool. The hash table mapping maps the page ID with one or more page descriptors that can be used to locate the in-memory image of the page associated with the aforementioned page ID. The page descriptor may further include the location of the page which is intended to be accessed. For example, the location of the page image to be accessed may be specified by the frame storing the page image, which in turn is identifiable through its frame ID.

Furthermore, approaches for structuring pages within memory are described. The structuring of data pages within memory, as per an example of the present disclosure, resolves issues and the overheads arising due to the latching of mapping data structures as mentioned above. In one example, a unique page identifier associated with a page image which is to be accessed, is identified. The unique page identifier may, in turn, be specified within a reference page which references the page image to be accessed. The page image to be accessed, referred hereinafter as the target page image, is in turn stored within a buffer pool. In another example, the target page image is stored within a frame in the buffer pool. Various pages within the buffer pool may be arranged in a hierarchical manner. In such a case the reference page image may form a parent node to the target page image being the child node.

As mentioned previously, page images may be evicted regularly to ensure that page images corresponding to the data which is accessed most is retained within the buffer pool. In such a case, it may be considered that the location specific identifier is a temporary identifier, as opposed to the unique page identifier.

As mentioned previously, generally the unique page identifier serves as the basis for searching different page images. In order to access the different page images, the corresponding pointer to the unique page identifier associated with the pages has to be obtained. Proceeding with the structuring of the data within the buffer pool, as per an example of the present disclosure, the reference page image is scanned to determine the unique page identifiers corresponding to one or more target page images.

Once identified, the reference page image may be modified to replace unique page identifiers with a corresponding location specific identifier. In an example, the referencing to the target page image may be implemented using pointers. For modifying, in an example, a pointer to the unique page identifier is swizzled, i.e., replaced with a pointer associated with the location specific identifier associated with the frame storing the target page image.

The location specific identifier may be indicative of the in-memory address location of the frame in which the target page image is stored. For example, in case a pointer is used, the pointer may point directly to the frame location storing the target page image. In the present manner, all page images within the buffer pool may be modified such that the page images include location specific identifiers associated with the respective frames storing the target page images.

In one example, the location specific identifier may be associated with a target frame descriptor. The target frame descriptor may further include metadata about the target page frame, which in turn is holding the target page image. In the present example, the target frame descriptor may further reference the frame location of the target frame, and thus the target page image as well.

In some cases, the target page being referenced may not be present within the buffer pool, i.e., the buffer pool does not have a corresponding page image. In that case, an in-memory page image of the target page is created. Once the page image is created, the memory location of the page image within the buffer pool is obtained, and subsequently used for determining the location specific identifier. Subsequently, the reference page image may be modified such that it includes the location specific identifier associated with the target page image.

In another example, to accommodate the newly created page image, one or more of the existing page images may be evicted from the buffer pool. Page images which are otherwise least likely to be referred to, may be identified as candidates and then evicted. In such a case, the reference page images which include another location specific identifier to a page image which is to be evicted, is modified. For modifying, the location specific identifier within the reference page image is changed to another unique page identifier. Such other unique page identifier may identify the location of candidate pages for eviction from the buffer pool, within the persistent storage medium where such pages are stored. It should also be understood that the candidate pages identified for eviction may also include respective location specific identifiers to other page images. In such a case, the location specific identifiers within the eviction candidate pages image are modified by replacing the location specific identifiers with other unique page identifiers. In the present example, the modification of the direct pointer may be obtained based on metadata associated with the buffer pool frame of the eviction candidate page image.

During processing, search requests may be directed to the target page images based on the respective location specific identifiers. For example, upon receiving a search key, the page image corresponding to the search key is initially determined. Upon obtaining the page image, the page image may be scanned. Since the page image now includes a location specific identifier associated with a target page image, and not the unique page identifier, the mapping which maps the unique page identifier to the target page image is not accessed. As a result of the location specific identifier, the requested page image is accessible directly. Consequently, overheads which would have arisen due to the latching of the mapping are avoided. As a result, computational costs for processing in general are also avoided, thereby resulting in an efficient processing system. In one example, the location specific identifier may be determined based on a mapping between the unique page identifiers and their respective frame locations within the buffer pool. For example, a hash table mapping may map the unique page identifiers of the target page images with their respective frame IDs.

It should be understood that the present disclosure pertains to any data management system that utilizes unique page identifier or other abstract identifiers to represent relationships between different page images stored in-memory by mapping such abstract identifiers and in-memory page images. Examples of such data structure include, but are not limited to, B-tree or Foster B-tree structures in traditional databases.

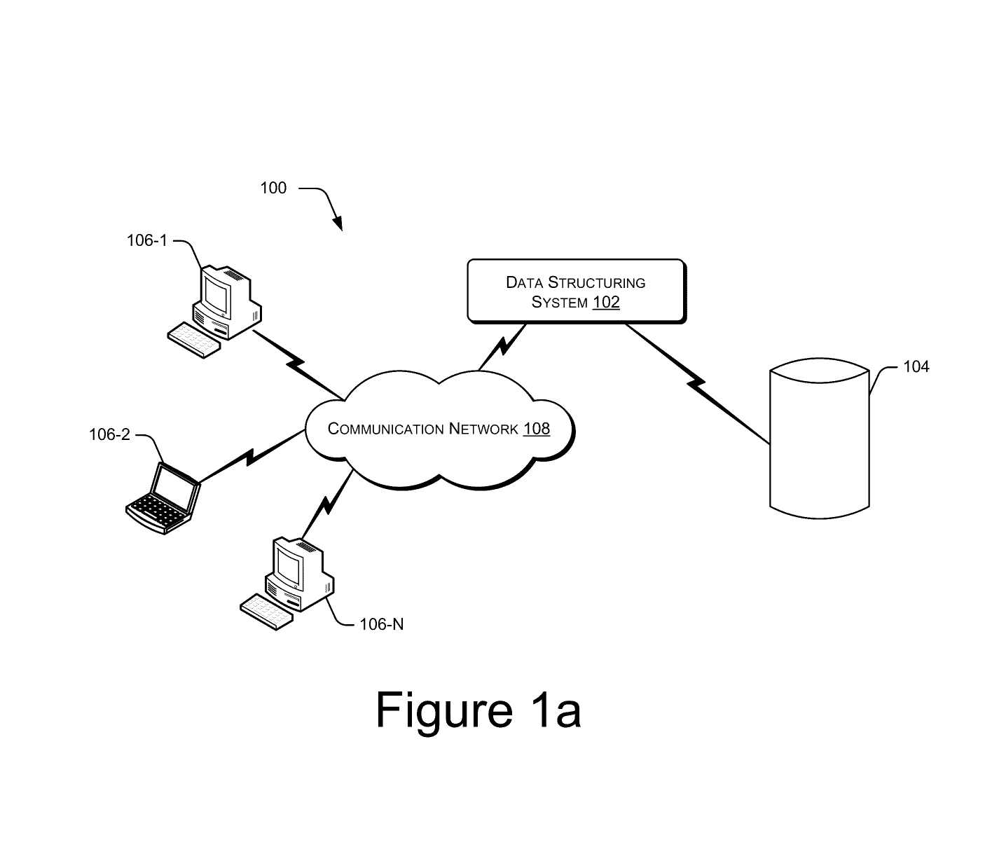

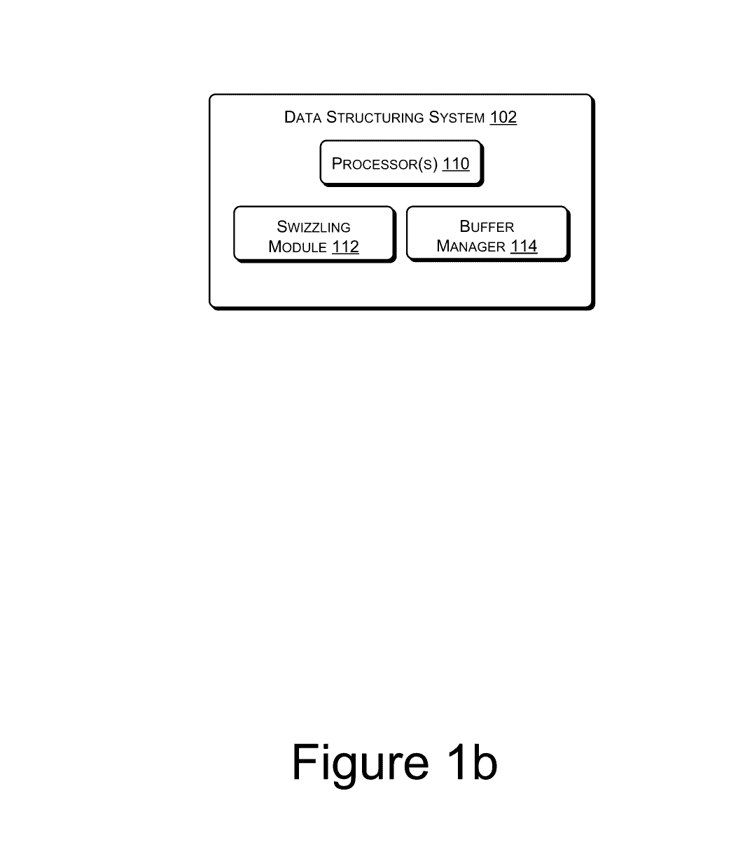

The above approaches are further described in conjunction with FIGS. 1 to 7. It should be understood that the description and figures merely illustrate examples implementations of the present disclosure. It is thus understood that various arrangements can be devised that, although not explicitly described or shown herein, embody the principles of the present disclosure and are included within its scope. Moreover, all statements herein reciting principles, aspects, and embodiments of the present disclosure, as well as specific examples thereof, are intended to encompass equivalents thereof.

FIG. 1a schematically illustrates a system environment 100 implementing a data structuring system 102, according to an example of the present disclosure. The system environment 100 may be a public environment or a private environment, The data structuring system 102 may be a machine readable instructions-based implementation or a hardware-based implementation or a combination thereof. The data structuring system 102 described herein can be implemented in a computing device, such as a server.

As shown in FIG. 1(a), the data structuring system 102 is communicatively coupled with a database 104, which in turn provides a persistent storage medium for data. The data structuring system 102 is coupled with a plurality of client devices 106-1, 106-2, . . . , 106-N through a communication network 108. The client devices 106-1, 106-2, . . . , 106-N, hereinafter may be collectively referred to as client devices 106, or individually referred to as a client device 106. The client devices 106 may be any computing device, such as a desktop computer, a laptop, a workstation, a tablet, a point of sale device, and the like. In an example, the data structuring system 102 can access the database 104 to receive and process data in response to requests received from one or more of the client devices 106.

FIG. 1(b) provides, as per an example of the present disclosure, various components of the data structuring system 102. As per an example, the data structuring system 102 includes processor(s) 110, a swizzling module 112 and a buffer manager 114. The processor(s) 110 may be implemented as microprocessors, microcomputers, microcontrollers, digital signal processors, central processing units, state machines, logic circuitries, and/or any devices that manipulate signals based on operational instructions. Among other capabilities, the processor(s) 110 fetch and execute computer-readable instructions stored in a memory. The functions of the various elements shown in FIG. 1(b), including any functional blocks labeled as “processor(s)”, may be provided through the use of dedicated hardware as well as hardware capable of executing machine readable instructions.

The data structuring system 102 is implemented with databases, such as the database 104, which uses an in-memory, for storing in-memory copies of data from the database 104. In an example, the memory may further include buffer pools. Buffer pools are portions within the in-memory which allow data to be positioned within a fast, and possibly transient, memory during processing. It should be understood that such transient memories includes but are not restricted to DRAM, NVRAM, Memristor, Phase-Change Memory, CPU cache, etc. This generally allows for quicker access time, when compared with access times for disks or other forms of persistent storage mediums. As mentioned previously, the data accessed from the database 104 is in the form of page images. The page images are subsequently stored in frames within the buffer pool. In order to access the page image, the appropriate frame storing the page is to be accessed.

The data within the database 104 may be arranged in a hierarchical format. For example, the page images may be arranged as nodes within a tree-like structure. The nodes may be parent nodes or children nodes, with each parent node possessing a reference or a pointer to a child node. In one example, the pointer may include reference to a unique page identifier associated with the child node. In the present example, the unique page identifier may uniquely identify the page image. However, when present in the buffer pool, the unique page identifier may not identify the memory location, i.e., the frame, which stores the page image being searched.

In operation, the data structuring system 102 structures the data within the buffer pool in a manner such that a reference page image, i.e., a parent page image, includes information relating to the memory location of a target page image, i.e., the child page image instead of the unique page identifier associated with the target page image. In one example, the swizzling module 112 analyzes the parent page image to determine the unique page identifier of the child page image, which it references. On determining the unique page identifier, the swizzling module 112 swizzles the unique page identifier to the child page image. Swizzling replaces the unique page identifier by a location specific identifier uniquely indicating the memory location of the frame storing the child page image. In one example, in case a pointer is used, the swizzling module 112 modifies a pointer based on the unique page identifier referenced in the parent page image, by replacing it with a direct pointer based on the location specific identifier. In such a case, the direct pointer within the parent page image is associated with the in-memory location of the frame storing target child page image.

Once the parent page image has been modified, all accesses to subsequent pages are based on the location specific identifier, and in turn the direct pointer. The swizzling may be implemented for any number of page images within the buffer pool. In one example, the direct pointer may either directly point to the memory location of the frame holding the child target page image, or may point to a frame descriptor data structure. A frame descriptor data structure includes information associated with the target frame holding the target page image. In an example, the frame descriptor data structure may include another pointer, pointing directly to the in-memory location of the target frame, and hence in turn the target page image. It should be understood that for each of the reference page image, a page specific reference is replaced with memory location specific reference.

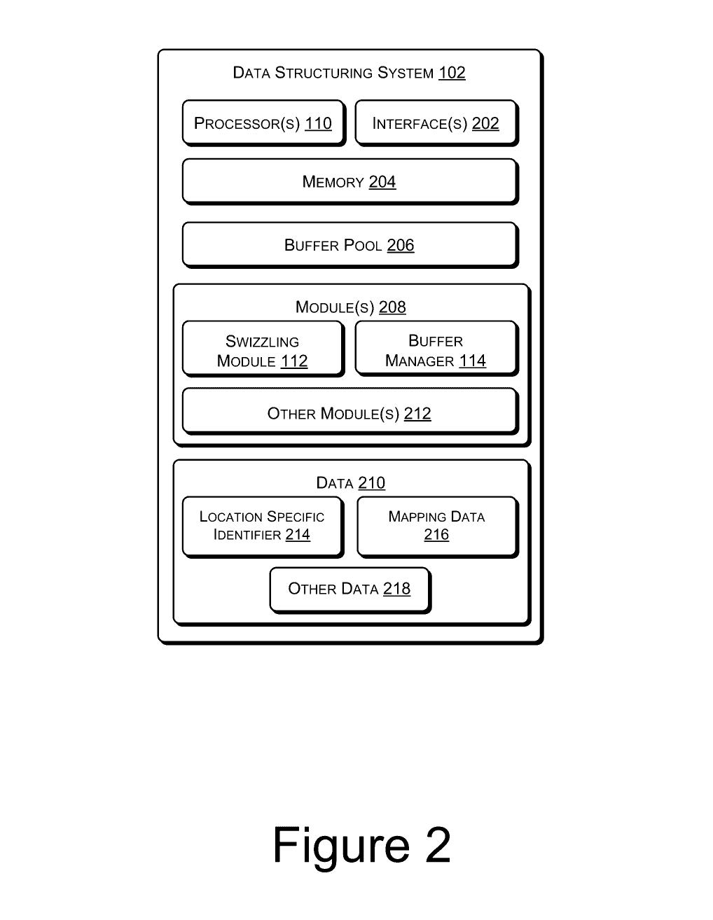

FIG. 2 illustrates the data structuring system 102, according to an example of the present disclosure. The data structuring system 102 includes processor(s) 110 and also interface(s) 202. The interface(s) 202 may include a variety of machine readable instruction-based and hardware interfaces that allow the data structuring system 102 to interact with the database 104 and the client devices 106, as the case may be. Further, the interface(s) 202 may enable the data structuring system 102 to communicate with other devices, such as network entities, web servers and/or other external repositories (not shown in FIG. 2).

The data structuring system 102 further includes memory 204 and a buffer pool 206, coupled to the processor(s) 110. The memory 204 may include any computer-readable medium including, for example, volatile memory (e.g., RAM), and/or non-volatile memory (e.g., EPROM, flash memory, NVRAM, memristor, etc.). The buffer pool 206 serves as a transient storage for data, and may be implemented as a volatile memory (e.g., RAM) or as a non-volatile memory (e.g., NVRAM). The data structuring system 102 further includes module(s) 208 coupled to the processor(s) 110. The module(s) 208 may include routines, programs, objects, components, data structures, and the like, which perform particular tasks or implement particular abstract data types. The module(s) 208 further include modules that supplement applications on the data structuring system 102, for example, modules of an operating system.

The module(s) 208 of the data structuring system 102 includes the swizzling module 112, the buffer manager 114 and other module(s) 212. The other module(s) 212 may include programs or coded instructions that supplement applications and functions, for example, programs in the operating system of the data structuring system 102.

The data structuring system 102 also includes data 210. The data 210 serves, amongst other things, as a repository for storing data that may be fetched, processed, received, or generated by the module(s) 208. Although the data 210 is shown internal to the data structuring system 102, it should be understood that the data 210, besides memory 204, may reside in an external repository in a storage disk (not shown in the figure) or a persistent storage medium, which may be coupled to the data structuring system 102. The data structuring system 102 may communicate with the external repository through the interface(s) 202 to obtain information from the data 210. In an example, the data 210 may further include location specific identifier 214, mapping data 216, and other data 218. The location specific identifier 214 uniquely identifying the memory location of the frame holding the target page image within the buffer pool 206. As mentioned previously, the buffer pool 206 may further include a plurality of frames, within each of which, a page is stored. Each of the frames may be further identifiable based on the location specific identifier 214 associated with a memory location storing the respective page images. In one example, the location specific identifier 214 may include a unique frame identifier. Example of the unique frame identifier includes, but is not limited to, a frame ID. It should be understood that additional levels of abstraction may exist between the memory location of the page image and the page identifier. For example, the frame used to manage the in-memory image of the page might be itself contained within a control block or other data structures. In such a case, such other data structures may be accessed to determine the memory location of the target page image being accessed.

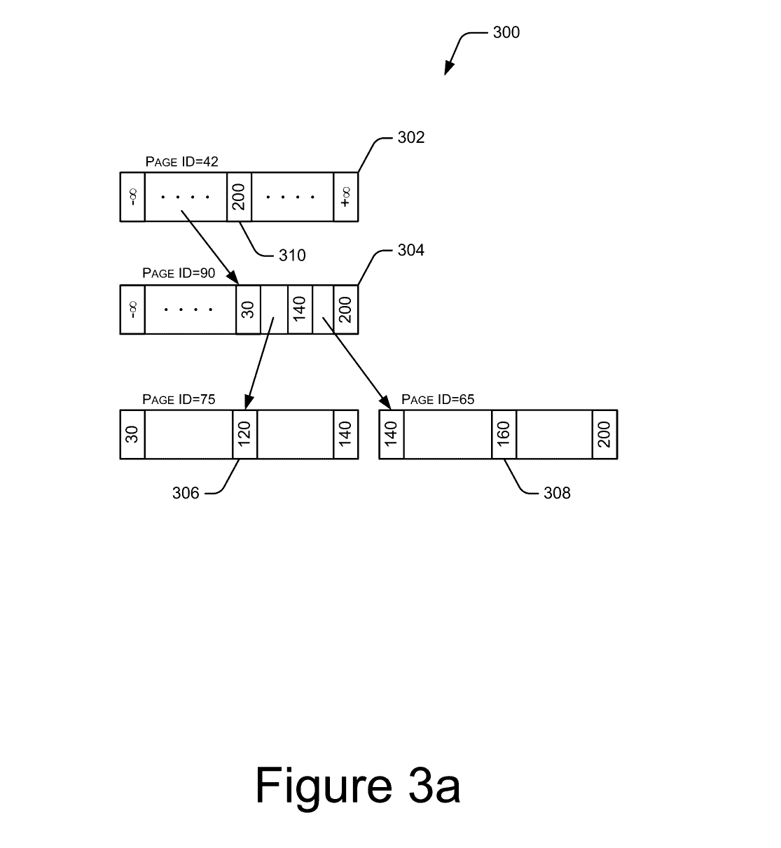

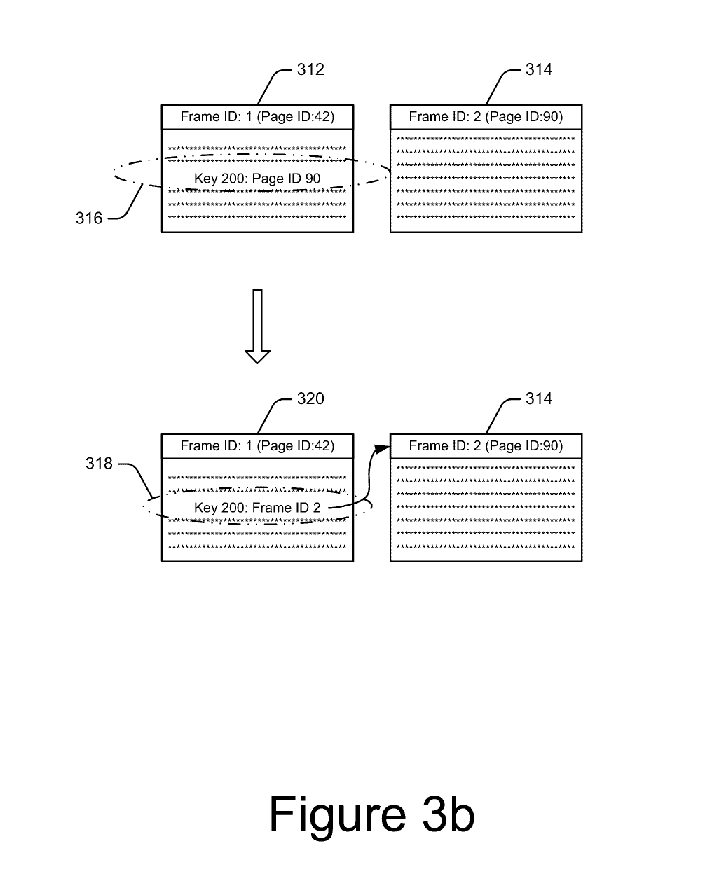

The working of the data structuring system 102 is explained in conjunction with FIG. 3(a)-(b). FIG. 3(a) illustrates a hierarchical structured tree 300 for storing data, say within the buffer pool 206, according to an example of the present disclosure. FIG. 3(a) provides a frame based representation of the data stored in the tree 300. Furthermore, FIG. 3(b) provides the frame based representation without and with modifications implemented upon the page images, respectively.

FIG. 3(a) illustrates a tree 300 depicting one or more nodes associated with each other. In the present example, the structure 300 is depicted as a B-tree type structure. However, other forms of hierarchical structure may also be used without deviating from the scope of the present disclosure. The tree 300 includes four nodes namely node 302, 304, 306 and 308. The node 302 being a reference page image forms the root node. The reference page image, i.e., the root node 302 references, either directly or indirectly, a plurality of target pages which in turn are depicted as nodes 304, 306, and 308. The nodes 304, 306, and 308, form the child nodes for the root node 302. As can be gathered, each of the nodes within the tree 300 includes one or more key separators 310, illustrated as 30, 120, 140, 160.

As mentioned previously, each of the nodes of the tree 300 may be stored in the buffer pool 206. In such a case, each of the nodes is representative of their respective page images within the buffer pool 206 (as depicted in FIG. 3(b)). Furthermore each of the page images may be associated with a unique page identifier, such as a page ID. In the present example, the root node 302 is associated with page ID=42. The other nodes 304, 306 and 308 are associated with page IDs 90, 75 and 65, respectively.

FIG. 3(b) provides an illustration depicting the in-memory page images corresponding to the nodes 302, i.e., the root node 302 and the child node 304. Each of the page images corresponding to node 302 and node 304 are provided within the frames 312 and 314, having frame IDs 1 and 2, respectively. As also provided in FIG. 3(b), the node 302 (with page ID=42) includes a pointer 316 to the node 304 by referencing a unique page identifier of the child node 304. In the present case, the unique page identifier associated with the node 304 is page 113=90.

In operation, the swizzling module 112 determines whether the pointer 316 to the unique page identifier is of the node 304 which is to be accessed, is present. On determining the pointer 316, the swizzling module 112 modifies the page image of the node 302 within the frame 312 (with Frame ID=1). The page image of the node 302 is modified by replacing the pointer 316, i.e., a reference to the unique page identifier, with a direct pointer 318. Once replaced, a modified page image 320 corresponding to the node 302 is obtained. In one example, the direct pointer 318 is associated with the memory location of the frame 314 (with the Frame ID=2) where the node 304 is stored. The information associated with the direct pointer is stored within the direct pointer data 214. In an example, the direct pointer data 214 may include information associated with the target page image in the form of metadata. In such a case, the memory location of the frame 314 may be determined from the metadata within the direct pointer data 214.

In another example, the direct pointer 318 for replacing the pointer 316 of the unique page identifier is determined based on a mapping between the unique page identifiers of the target page image, and their respective frame locations within the buffer pool 206. The mapping between the unique page identifier and the frame locations may be provided in the mapping data 216. For example, the mapping data 216 may provide a hash table mapping which associates the unique page identifiers of the target page images with their respective frame IDs. The mapping within the mapping data 216 may provide the unique page identifier as a byte offset into a raw data file. Furthermore, the associated frame identifiers might be specified as an index into an array of the buffer pool frames.

Once the page images have been modified subsequent processing may be based on the direct pointers, such as direct pointer 318. For example, in case any operation requires a specific page image, the swizzling module 112 obtains a search key. The search key may be based on a search or navigation request received from one or more of the client devices 106, or may be a result of execution of one or more queries on the database 104. On receiving the same, the buffer manager 114 may determine whether an entry corresponding to the search key exists in any one or more page images. On obtaining a reference page image, (for example as that indicated by frame 320) which includes an entry corresponding to the search key, the buffer manager 114 determines the next page indicated by the frame 314 based on the direct pointer 318. The process is repeated till a result is obtained in response to the search key.

During the course of processing, one or more page images may have to be evicted from the buffer pool 206 so as to accommodate pages for carrying out other processing activities. Such a case may arise when a unique page identifier of a reference page image such as frame 312, may point to a page that presently is not present within the buffer pool 206. In such a case, the new page may be copied in-memory into a frame made available. Once the referenced page image has been copied in-memory, the unique page identifier of the frame 312 may be modified so that the frame includes a direct pointer, such as direct pointer 318, to the new page image. A page image for eviction may be selected as a candidate, on determining whether a page image under consideration is least likely to be needed for processing workload. For example, the buffer manager 114 may determine such a candidate page image based on how frequently is the candidate page image being accessed. If the access frequency is low, it may be assumed that such a page image would not be likely to be accessed soon.

As for the candidate page image which is to be evicted, the buffer manager 114 determines whether the candidate page image is referenced by direct pointer 318 specified within a reference page image. On determining the presence of a corresponding direct pointer, the buffer manager 114 may unswizzle or modify the page image of the reference page image by replacing the direct pointer with a pointer to the unique page identifier.

The unique page identifier may be identified through various mechanisms. For example, the unique page identifier may be identified based on information stored in the page image or metadata associated with the frame storing the candidate page image. In another example, the unique page identifier of the candidate page image may be determined from the buffer pool metadata. Based on the metadata associated with either the buffer pool frame or the buffer pool itself, the buffer manager 114 may determine the unique page identifier and modify the reference page image linked to it by reverting its pointer to the prior unique page identifier. Subsequently the buffer manager 114 may evict the candidate page image from the buffer pool 206. Although the manner in which the page images have been modified has been explained in conjunction with pointers, the same should not be considered as a limitation.

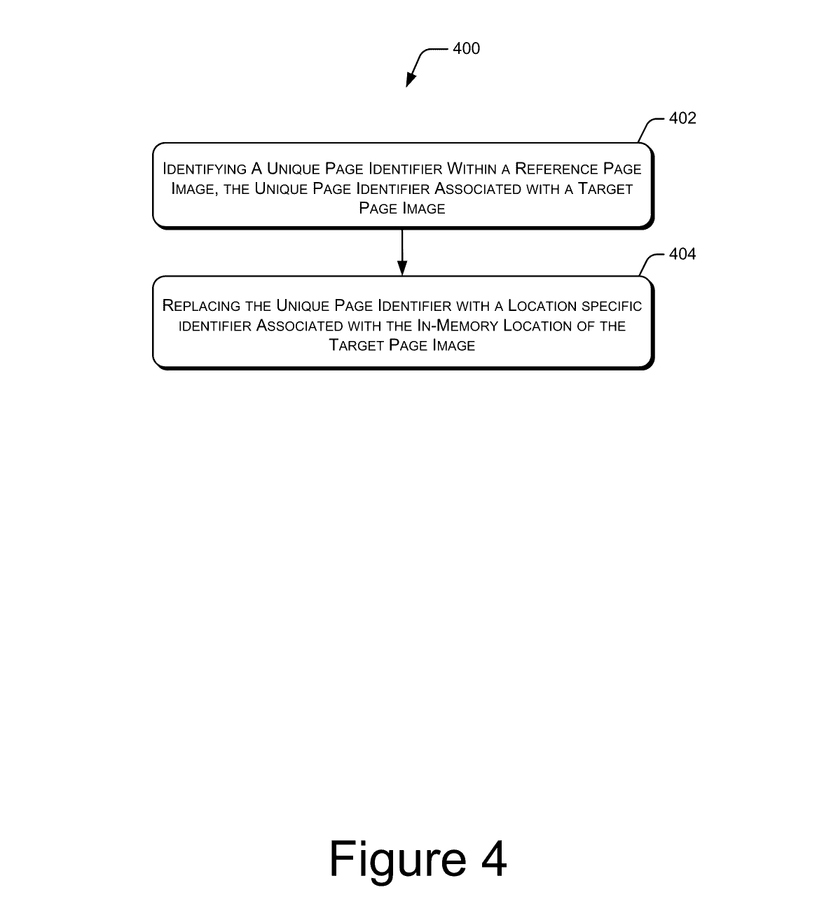

FIG. 4 illustrates a method 400 for structuring data within a buffer pool, according to an example of the present disclosure. The order in which the method 400 is described is not intended to be construed as a limitation, and any number of the described method blocks may be combined in any order to implement the method 400, or an alternative method.

Further, although the method 400 for structuring data within the buffer pool may be implemented in a variety of logical circuitry, in an example described in FIG. 4, the method 400 is explained in context of the aforementioned system 102.

Referring to FIG. 4, at block 402 a unique page identifier associated with a target page image is identified within a reference page. For example, the swizzling module 112 may scan the reference page image, such as that depicted by node 302, to identify a unique page identifier associated with a target page image 304. In the present example, the swizzling module 112 determines a pointer, such as the pointer 316, within the reference page image referencing the unique page identifier of the target page image as depicted by node 304.

At block 404, the unique page identifier of the target page image is replaced by a location specific identifier associated with the memory location storing the target page image. The target page image may be stored within a frame in the buffer pool. For example, the swizzling module 112 may replace the unique page identifier (associated with the target page image, i.e., node 304), referenced in the root node 302, with a location specific identifier associated with the memory location of the node 304. In another example, the swizzling module 112 further determines a pointer 316 associated with the unique page identifier and replaces it with a direct pointer 318 associated with the location specific identifier. In one example, location specific identifier may include a unique frame identifier or a frame ID, such as the frame 314 storing the target page image. For replacing the pointer 316 with the direct pointer 318, the swizzling module 112 modifies the reference page image. The direct pointer 318 may be determined based on the mapping data 216. In such a manner, for accessing the target page image, no mapping data structure correlating the unique page identifier with the memory location is accessed.

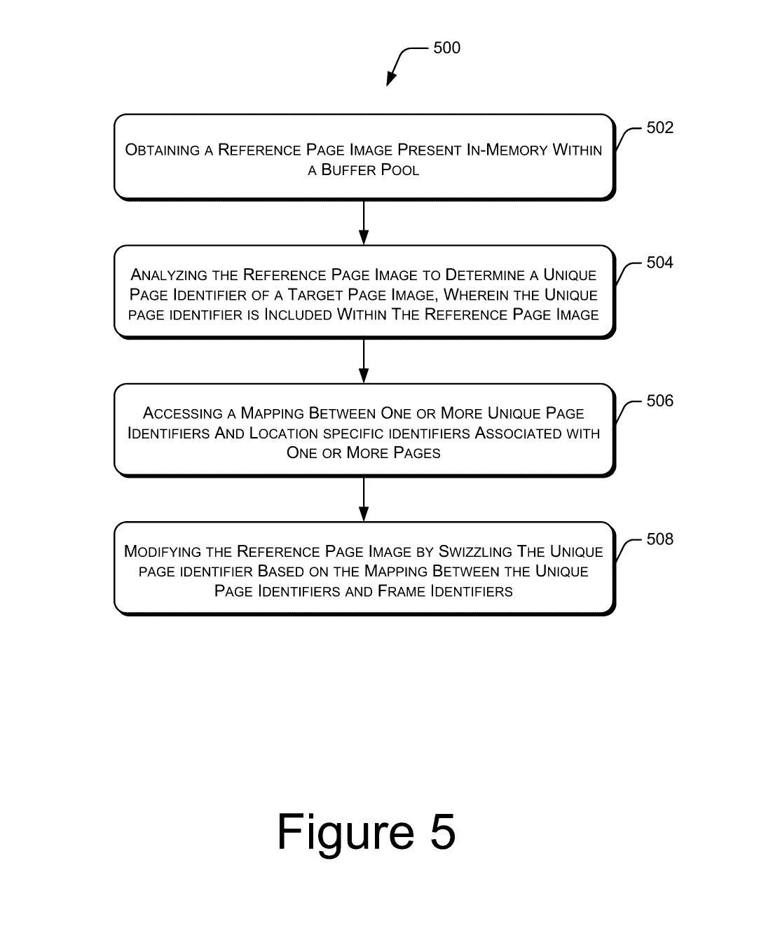

FIG. 5 illustrates a method 500 for structuring data within a buffer pool, according to an example of the present disclosure. The order in which the method 500 is described is not intended to be construed as a limitation, and any number of the described method blocks may be combined in any order to implement the method 500, or an alternative method.

At block 502, a reference page image present in-memory, for example within a buffer pool, is obtained. The reference page image thus obtained is linked to a target page image present within the buffer pool. To this end, the reference page image includes a unique page identifier of the target page image. In one example, the swizzling module 112 obtains a reference page image stored in a frame 312 based on search key. The reference page image and the target page image are stored in frames within the buffer pool 206.

At block 504, the reference page image is analyzed to determine the unique page identifier of the target page image. For example, the swizzling module 112 may parse the reference page image stored in frame 312 to determine the unique page identifier of the target page image being referenced. In another example, the unique page identifier may be associated with a pointer 316 to the target page image stored in frame 314. An example of the unique page identifier, includes but is not limited to, a page ID.

At block 506, a mapping between the unique page identifiers and location specific identifiers associated with one or more frames, is accessed. For example, the swizzling module 112 may access the mapping data 216 to determine location specific identifiers corresponding to one or more unique page identifiers. The location specific identifiers, may amongst other things, indicate the memory location of the frame within the buffer pool 206. In one example, the mapping data 216 may include a hash table mapping the unique page identifiers as a byte offset in a raw file, with the frame location which in turn may be represented as an index in an array of frame within the buffer pool 206.

At block 508, the reference page image is modified by swizzling the unique page identifier of the target page image. In doing so, the unique page identifier provided within the reference page image is replaced with a corresponding location specific identifier. The location specific identifier may include unique frame identifiers such as a frame ID. In one example, on determining the mapping between one or more unique page identifiers, the swizzling module 112 swizzles or modifies a pointer associated with the unique page identifier within the reference page image. While modifying, the swizzling module 112 replaces the pointer 316 to the unique page identifier with the direct pointer 318 to the frame 314 storing the target page image.

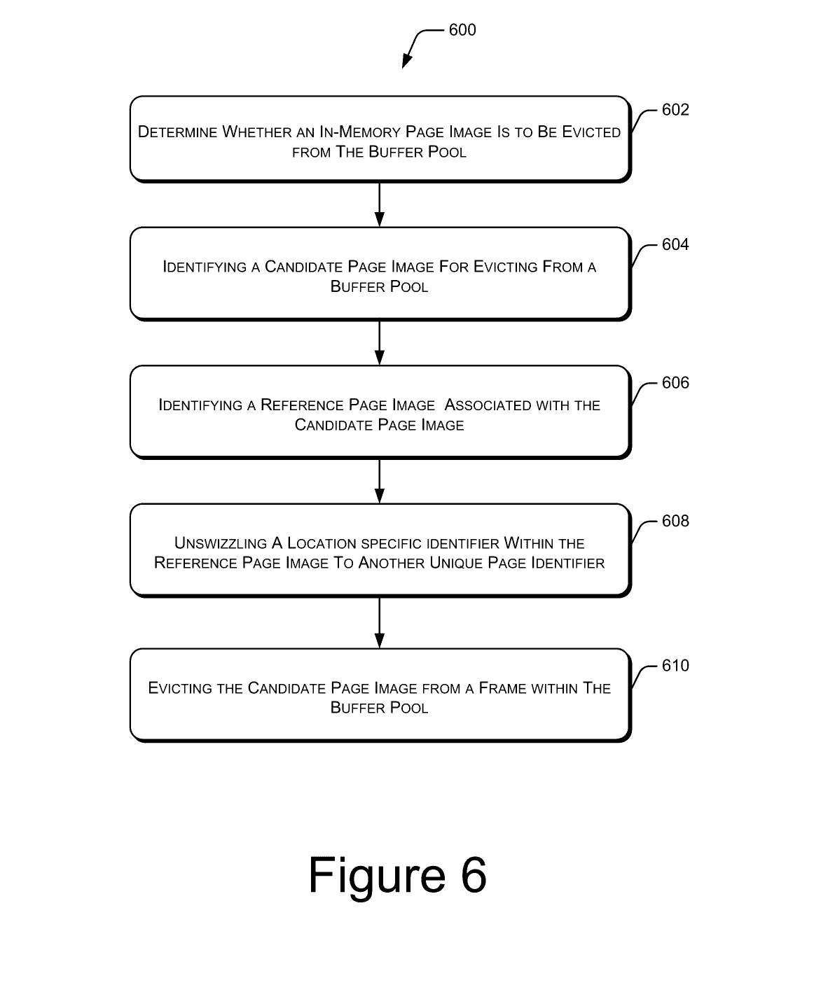

FIG. 6 illustrates a method 600 for structuring data within a buffer pool, according to an example of the present disclosure. The order in which the method 600 is described is not intended to be construed as a limitation, and any number of the described method blocks may be combined in any order to implement the method 600, or an alternative method.

At block 602, it is determined whether an in-memory page image is to be evicted. For example, buffer manager 114 may determine that one or more frames within the buffer pool 206 may have to be made available for new pages, in case any existing page image in-memory refers to a page which is not present in-memory.

At block 604, a candidate page image for evicting from the buffer pool is identified. For example, the buffer manager 114 may determine the candidate page image based on an access frequency. If the access frequency is low, it may be assumed that such a page image would not be likely to be accessed soon. Other possible methods for determining which page to evict include least-recently-used, first-in, random, etc. At block 606, a respective reference page image associated with the candidate page image is identified. For example, the buffer manager 114 may identify the reference page image associated with the candidate page image based on a direct pointer included within the reference page image.

At block 608, the location specific identifier associated with the identified reference page image is unswizzled such that the reference page image includes a unique page identifier of candidate page image. The unique page identifier of the candidate page image, in an example, may uniquely identify the candidate page image when stored in a persistent storage medium. In another example, the swizzling module 112 may unswizzle the direct pointer associated with the location specific identifier in the reference page image, back to its unique page identifier. In one example, the unique page identifier may be determined based on information stored in the page image or metadata associated with the frame storing the candidate page image. In another example, the unique page identifier of the candidate page image may be determined from the buffer pool metadata. In yet another example, there might be an external data structure mapping unique page identifiers to in-memory images of pages.

At block 610, the candidate page image is evicted from the frame within the buffer pool. For example, the buffer manager 114 may evict the candidate page image from the frame within the buffer pool 206. The frame may then be made available for accommodating new page images.

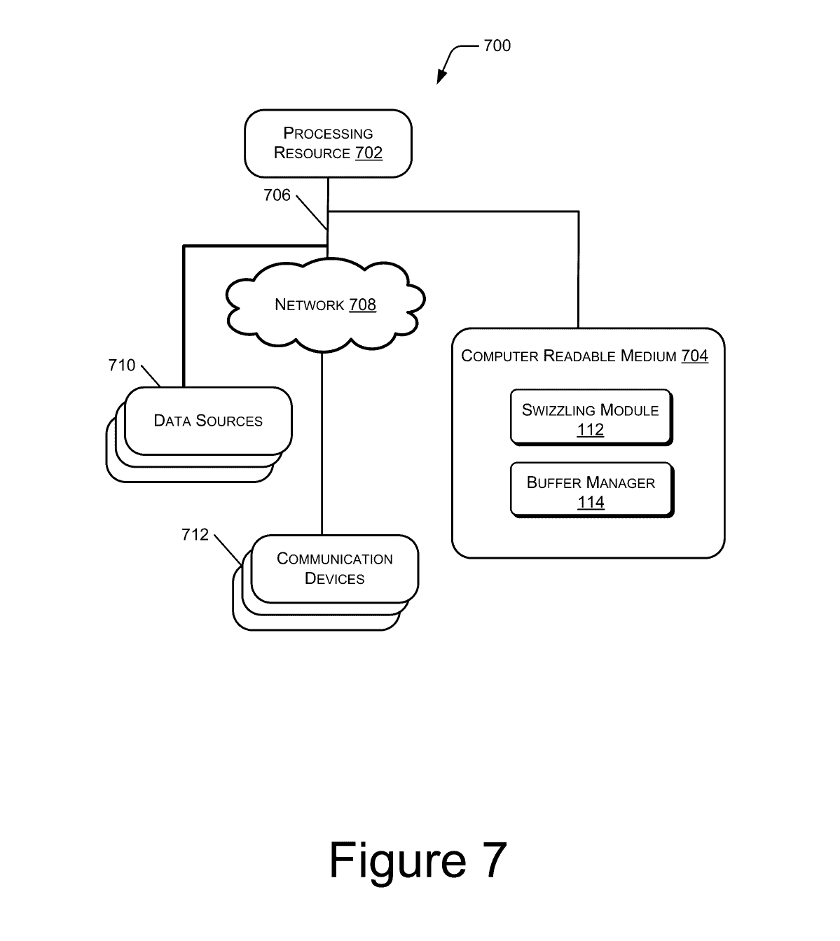

FIG. 7 illustrates a system environment 700 for structuring data within a buffer pool, according to an example of the present disclosure. The system environment 700 may be a public networking environment or a private networking environment. In one implementation, the system environment 700 includes a processing resource 702 communicatively coupled to a computer readable medium 704 through a communication link 706.

For example, the processing resource 702 can be a computing device for structuring data within a buffer pool. The computer readable medium 704 can be, for example, an internal memory device or an external memory device. In one implementation, the communication link 706 may be a direct communication link, such as any memory read/write interface. In another implementation, the communication link 706 may be an indirect communication link, such as a network interface. In such a case, the processing device 702 can access the computer readable medium 704 through a network 708. The network 708 may be a single network or a combination of multiple networks and may use a variety of different communication protocols.

The processing resource 702 and the computer readable medium 704 may also be communicatively coupled to data sources 710 through the communication link 706, and/or to communication devices 712 over the network 708. The coupling with the data sources 710 enables in receiving the string data in an offline environment, and the coupling with the communication devices 712 enables in receiving the string data in an online environment.

In one implementation, the computer readable medium 704 includes a set of computer readable instructions, such as a swizzling module 112 and a buffer manager 114. The set of computer readable instructions can be accessed by the processing resource 702 through the communication link 706 and subsequently executed to process data communicated with the data sources 710.

For example, the swizzling module 112 analyzes a reference page image to determine the unique page identifier of the child page image (also referred to as the target page image), which it references. On determining the unique page identifier, the swizzling module 112 replaces the unique page identifier with a location specific identifier. The location specific identifier may indicate the memory location of the frame storing the target page image within the buffer pool. In an example, the swizzling module 112 swizzles a pointer associated with the unique page identifier of the target page image, by replacing it with a direct pointer associated with the location specific identifier. In one example, the direct pointer within the parent page image refers to the memory location at which the child page image is stored. Once the parent page image has been modified, the buffer manager 114 may manage all accesses to subsequent pages based on the direct pointer.

Although examples for the present disclosure have been described in language specific to structural features and/or methods, it should stood that the appended claims are not necessarily limited to the specific features or methods described. Rather, the specific features and methods are disclosed and explained as examples of the present disclosure.

I/We claim:

1. A method of structuring a plurality of page images in-memory, the method comprising:
identifying a unique page identifier provided within a reference page image, wherein the unique page identifier is associated with a target page image present in-memory, and uniquely identifies the target page image when stored in a persistent storage medium; and
replacing the unique page identifier associated with the target page image with a location specific identifier, wherein the location specific identifier is associated with the in-memory location of the target page image.

2. The method as claimed in claim 1, wherein the unique page identifier provided within the reference page image is associated with a pointer.

3. The method as claimed in claim 1, wherein the replacing the unique page identifier further comprises:
accessing a mapping between a plurality of unique page identifiers of a plurality of page images and corresponding in-memory locations of the plurality of page images; and
obtaining, based on the mapping, the location specific identifier corresponding to the unique page identifier of the target page image.

5. The method as claimed in claim 1, wherein in-memory data access speed is greater than data access speed of the persistent storage medium.

6. The method as claimed in claim 1, wherein the plurality of the page images in-memory is hierarchically arranged in a B-tree type structure.

7. A system for structuring a plurality of page images stored in-memory, the system comprising:
a processor;
a swizzling module coupled to the processor to,
detect, associated with a target page image stored in-memory, a unique page identifier included within a reference page image stored in-memory; and
modify the reference page image to replace the unique page identifier with a location specific identifier associated with a frame storing the target page image; and
a buffer manager coupled to the processor to, redirect access requests to the frame storing the target page image based on the location specific identifier,

8. The system as claimed in claim 7, wherein the location specific identifier includes a frame ID.

9. The system as claimed in claim 7, wherein to modify the reference page image, the swizzling module is to,
identify a pointer associated with the unique page identifier; and
swizzle the pointer associated with the unique page identifier, wherein to swizzle further comprises replacing the pointer associated with the unique page identifier with the pointer associated with the location specific identifier.

10. The system as claimed in claim 7, wherein to determine the location specific identifier the swizzling module is to,
access a mapping data structure, wherein the mapping data structure maps the unique page identifier with a parameter associated with the in-memory location of the frame storing the target page image; and
determine the location specific identifier based on the parameter.

11. The system as claimed in claim 7, wherein the buffer manager is further to,
identify a candidate page image for evicting from a frame in-memory;
identify another reference page image referencing the candidate page image; unswizzle an another location specific identifier in the reference page image to obtain another unique page identifier, wherein the another location specific identifier is associated with the candidate page image, and wherein the another unique page identifier uniquely identifies the candidate page image stored in a persistent storage medium; and
evict the candidate page image from in-memory.

12. The system as claimed in claim 11, wherein the buffer manager is to unswizzle based on at least one of,
a mapping between a plurality in-memory locations;
metadata associated with a frame storing the candidate page image; and
information provided within the candidate page image.

14. A non-transitory computer-readable medium having a set of computer readable instructions that, when executed, cause a system for structuring a plurality of page images in-memory, to:
modify, within a reference page image, a unique page identifier associated with a target page image stored in a target frame, to a location specific identifier associated with the target frame; and
redirect access requests to the target frame based on the location specific identifier, wherein the reference page image and the target page image are stored within frames in-memory.

15. The non-transitory computer-readable medium as claimed in claim 14, wherein the target frame stores the target page image to be accessed based on a search query.
